(19) United States
(12) Patent Application Publication
(10) Pub. No.: US 2014/0156516 A1
(43) Pub. Date: Jun. 5, 2014

(54) PROVIDING CUSTOM SCRIPTS FOR CONTENT FILES

(71) Applicant: VERIZON PATENT AND LICENSING INC., Basking Ridge, NJ (US)

(72) Inventors: Sameer GAVADE, Irving, TX (US); Venkata S. ADIMATYAM, Irving, TX (US)

(73) Assignee: Verizon Patent and Licensing Inc., Basking Ridge, NJ (US)

(21) Appl. No.: 13/690,650

(22) Filed: Nov. 30, 2012

(51) Int. Cl. G06F 17/30

(52) U.S. Cl. CPC G06F 17/30023
USPC 705/40; 707/769; 707/752

(57) ABSTRACT

A first server may: receive, from a user device, an indication of a selection of a particular content file; provide a first query to request a script list having a list of one or more scripts associated with the particular content file, each one of the one or more scripts including an instruction to direct the user device to modify playback of the particular content file; receive, a response to the first query including the script list; and provide one of the one or more scripts to the user device, the user device being capable of executing the instruction of the one of the one or more scripts to modify playback of the particular content file when the user device plays the particular content file.

### BACKGROUND

User devices are sometimes used to receive a content file (e.g., a video content file, an audio content file, etc.) from a content provider via a network. User devices can modify playback of the content file to skip a portion of the content file in which the user may not be interested (e.g., an advertisement). Manually modifying playback of the content file is often cumbersome and time-consuming.

### BRIEF DESCRIPTION OF THE DRAWINGS

FIG. 1 illustrates an example overview of an implementation described herein;

FIG. 2 illustrates an example environment in which systems and/or methods, described herein, may be implemented;

FIG. 3 illustrates example components of a device that may be used within the environment of FIG. 2;

FIGS. 4-5 illustrate example data structures that may be stored by one or more devices in the environment of FIG. 2;

FIG. 6 illustrates a flowchart of an example process for providing a script to a user device;

FIG. 7 illustrates an example use case as described herein; and

FIG. 8 illustrates an example use case as described herein.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may permit a user device to receive and execute a script associated with a particular content file (e.g., a video or audio content file stored by a user device, a content storage device, or a live streaming content file corresponding to a live television broadcast or a live web broadcast). For example, the script may include an instruction to modify playback of the particular content file, such as an instruction to direct the user device to start playback of the particular content file, pause playback of the particular content file at a particular time index, fast forward playback of the particular content file at a particular time index, or rewind playback of the particular content file at a particular time index.

In some implementations, the systems and/or methods may store respective scripts for multiple content files. Thus, each content file may be associated with one or more custom scripts, which may be selected by a user of the user device. The user device may execute the selected custom script to modify playback of the content file.

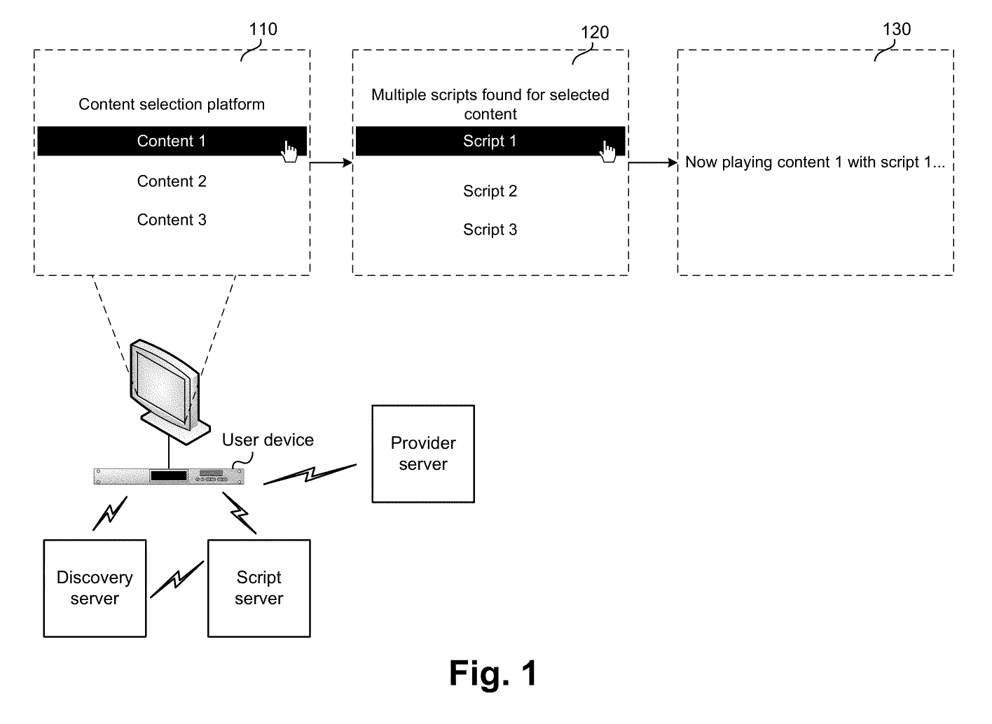

FIG. 1 illustrates an example overview of an implementation as described herein. As shown in FIG. 1, a user may use a user device, such as a set-top box for a television or display, to request, from a provider server, a particular content file by selecting the particular content file (e.g., via a content selection platform as shown in interface 110). In FIG. 1 assume that a user, associated with the user device, requests the particular content file having the identification “content 1” In some implementations, a discovery server may receive an indication of selection of the particular content file. The discovery server may store information to identify scripts associated with the particular content file (e.g., based on an identifier of the particular content file) and may communicate with a script server to provide script(s), associated with the particular content file, to the user device.

In FIG. 1, assume that the discovery server identifies three unique scripts associated with the particular content file. As shown in interface 120 of FIG. 1, the script server may provide a list having the three scripts to the user device such that the user device may present an option to select one of the three scripts. In FIG. 1, assume that the user selects script 1. As shown in interface 130, the user device may apply script 1 and execute instructions associated with script 1. As described above, the script may include an instruction to pause, play, rewind, and/or fast forward within the particular content file.

As a result, different content files may include respective scripts with instructions to direct the user device to begin playback, pause playback, rewind playback, fast forward playback, or modify playback of the particular content file in some other manner. Additionally, or alternatively, a script may direct the user device to perform some other task (e.g., open a web page, play a different content file, open an application, etc.). In some implementations, a particular script may be associated with a payment charge value. Thus, a user, associated with the user device, may agree to incur a charge in exchange for being able to use the script.

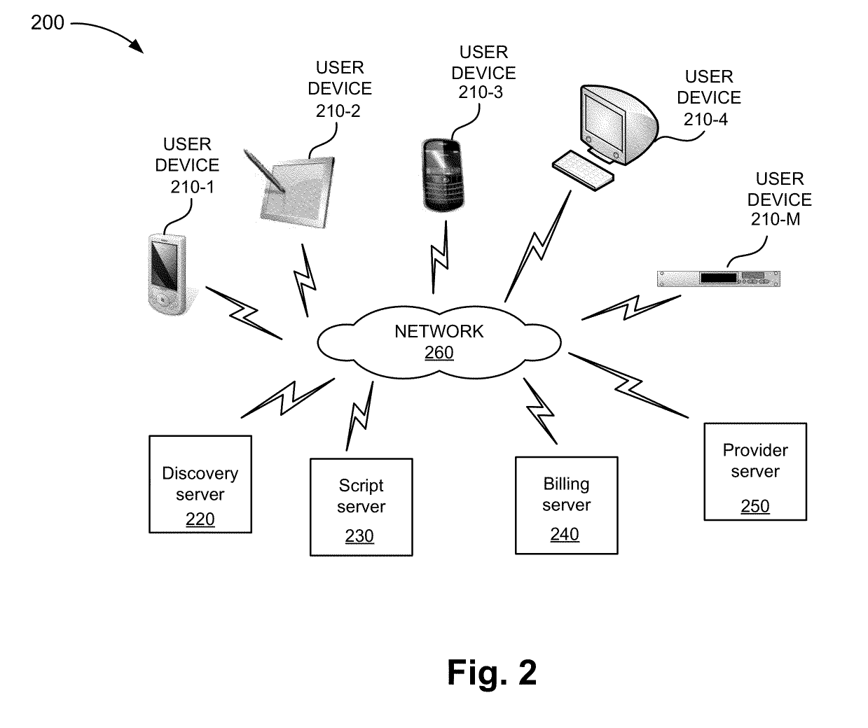

FIG. 2 is a diagram of an example environment 200 in which systems and/or methods described herein may be implemented. As shown in FIG. 2, environment 200 may include user device 210-1, . . . , 210-M (where M≧1), discovery server 220, script server 230, billing server 240, provider server 250, and network 260.

User device 210 may include a device capable of communicating via a network, such as network 260. For example, user device 210 may correspond to a mobile communication device (e.g., a smart phone or a personal digital assistant (PDA)), a portable computer device (e.g., a laptop or a tablet computer), a gaming device, a set-top box, a desktop computer, or some other device. In some implementations, user device 210 may communicate with discovery server 220 to request a particular content file stored by provider server 250. User device 210 may include an associated display (e.g., a television display, a monitor, etc.). In some implementations, user device 210 may correspond to a client device, such as computing device to provide a script for a particular content file to script server 230.

Discovery server 220 may include a computing device, such as a server device, or a collection of server devices. In some implementations, discovery server 220 may receive an indication of a selection of a particular content file selected by user device 210 (e.g., a content file stored by user device 210, provider server 250, or stored by some other device). As described above, discovery server 220 may determine an identifier of the particular content file and may store information that identifies a script associated with the particular content file. In some implementations, discovery server 220 may determine an identifier of user device 210 and may identify a script associated with the identifier of user device 210 and the identifier of the particular content file. For example, a particular script for a particular content file may be accessible by a first user device 210 but not accessible by a second user device 210.

In some implementations, discovery server 220 may receive an indication, from script server 230, that a script has been provided for storage to script server 230. In some implementations, discovery server 220 may communicate with billing server 240 to identify that a particular script (e.g., a script having an associated payment charge value) has been delivered to user device 210.

Script server 230 may include a computing device, such as a server device, or a collection of server devices. In some implementations, script server 230 may store a script associated with a particular content file. As described above, script server 230 may receive an instruction from discovery server 220 to provide a particular script to user device 210 when discovery server 220 identifies the particular script associated with a particular content file requested by user device 210. In some implementations, script server 230 may receive scripts from user device 210 (e.g., via a user interface of user device 210), from provider server 250, or from some other source. Script server 230 may assign a script identifier to a received script for storage.

Billing server 240 may include a computing device, such as a server device, or a collection of server devices. In some implementations, billing server 240 may receive script delivery information from script server 230. In some implementations, billing server 240 may perform a billing settlement function to assess debits and credits to corresponding accounts of user device 210, provider server 250, or some other account, based on the script delivery information received by discovery server 220.

Provider server 250 may include a computing device, such as a server device, or a collection of server devices. In some implementations, provider server 250 may store a particular content file and may provide the particular content file to user device 210 (e.g., via a caching server or via some other intermediate server). In some implementations, provider server 250 may be associated with an owner of the particular content file and may provide scripts to script server 230 for delivery to user device 210 at an advertised payment charge value. Additionally, or alternatively, provider server 250 may be associated with a live broadcasting headend system, such as a system to provide a content file (e.g., in the form of a live television broadcast or a live web broadcast).

Network 260 may include one or more wired and/or wireless networks. For example, network 250 may include a cellular network, a public land mobile network (PLMN), a second generation (2G) network, a third generation (3G) network, a fourth generation (4G) network, a fifth generation (5G) network, and/or another network. Additionally, or alternatively, network 260 may include a local area network (LAN), a wide area network (WAN), a metropolitan network (MAN), a telephone network (e.g., the Public Switched Telephone Network (PSTN)), an ad hoc network, a managed IP network, a virtual private network (VPN), an intranet, the Internet, a fiber optic-based network, and/or combination of these or other types of networks.

The quantity of devices and/or networks, illustrated in FIG. 2, is not limited to what is shown. In practice, there may be additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. For example, discovery server 220 and script server 230 could be implemented within a single server device or a collection of server devices. Devices of environment 200 may interconnect via wired connections, wireless connections, or a combination of wired and wireless connections.

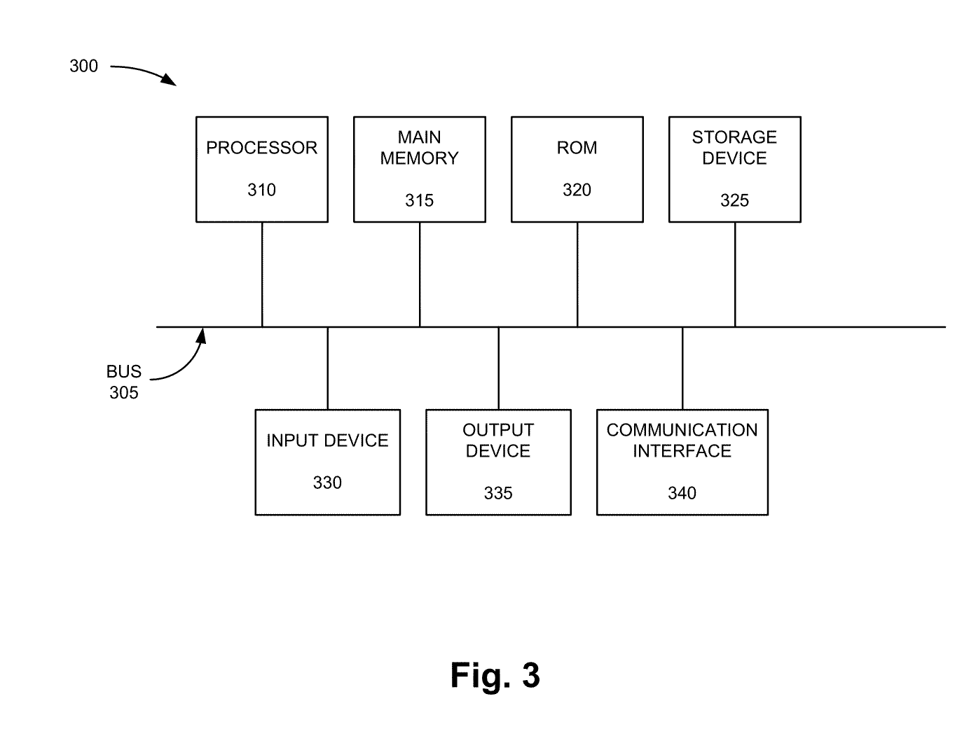

FIG. 3 illustrates example components of a device 300 that may be used within environment 200 of FIG. 2. Device 300 may correspond to user device 210, discovery server 220, script server 230, billing server 240, or provider server 250. Each of user device 210, discovery server 220, script server 230, billing server 240, or provider server 250 may include one or more devices 300 and/or one or more components of device 300.

As shown in FIG. 3, device 300 may include a bus 305, a processor 310, a main memory 315, a read only memory (ROM) 320, a storage device 325, an input device 330, an output device 335, and a communication interface 340. In some implementations, device 300 may include additional components, fewer components, different components, or differently arranged components.

Bus 305 may include a path that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a component that permits an operator to input information to device 300, such as a control button, a keyboard, a keypad, or another type of input device. Output device 335 may include a component that outputs information to the operator, such as a light emitting diode (LED), a display, or another type of output device. Communication interface 340 may include any transceiver-like mechanism that enables device 300 to communicate with other devices or networks. In one implementation, communication interface 340 may include a wireless interface, a wired interface, or a combination of a wireless interface and a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include memory space within a single physical storage device or memory space spread across multiple physical storage devices.

The software instructions may be read into main memory 315 from another computer-readable medium, such as storage device 325, or from another device via communication interface 340. The software instructions contained in main memory 315 may direct processor 310 to perform processes that will be described later. Alternatively, hardwired circuitry may be used in place of or in combination with software instructions to implement processes described herein. Thus, implementations described herein are not limited to any specific combination of hardware circuitry and software.

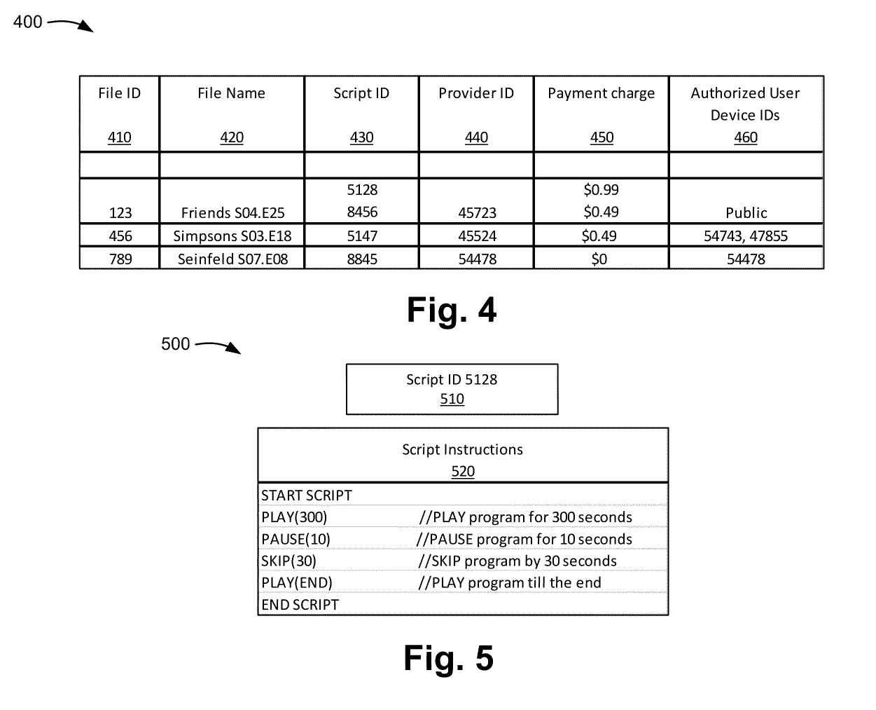

FIG. 4 illustrates an example data structure 400 that may be stored by one or more devices in environment 200, such as discovery server 220. In one implementation, data structure 400 may be stored in a memory of discovery server 220. In another implementation, data structure 400 may be stored in a memory separate from, but accessible by discovery server 220. In some implementations, data structure 400 may be stored by some other device in environment 200, such as script server 230, billing server 240, or provider server 250.

A particular instance of data structure 400 may contain different information and/or fields than another instance of data structure 400. In some implementations, each entry in data structure 400 may relate to a particular content file having an associated script stored by script server 230.

As shown in FIG. 4, data structure 400 may include file identifier (ID) field 410, file name field 420, script ID field 430, provider ID field 440, payment charge field 450, and authorized user device IDs field 460.

File ID field 410 may include information to uniquely identify a particular content file having an associated script stored by script server 230. For example, file ID field 410 may store a string of characters to identify the particular content file. While a particular format of an identifier stored by file ID field 410 is shown in FIG. 4, in practice, file ID field 410 may store an identifier in any format and having any length.

File name field 420 may include information, such as a narrative, that describes a particular content file associated with a particular file ID. As an example shown in FIG. 4, file name field 420 may store the file name “Friends S04.E25” (e.g., corresponding to the television shown Friends 4, episode 25) to describe the particular content file associated with the file ID “123.”

Script ID field 430 may include information to uniquely identify one or more scripts stored by script server 230 associated with a particular content file. For example, script ID field 430 may store a string of characters to identify a particular script. As an example shown in FIG. 4, script ID field 430 may store information to identify that the particular script having the script ID “5128” is associated with the content file having the content file ID “123.” Further, the particular script having the script ID “8456” is also associated with the content file having the content file ID “123.”

Provider ID field 440 may include information to uniquely identify a provider associated with a particular content file. For example, provider ID field 440 may store an account number, or some other identifier, to identify the provider associated with the particular content file and/or with a particular script. For example, provider ID field 440 may store information to identify a particular provider server 250 which user device 210 may communicate with to receive the particular content file and identify an account, associated with a particular provider server 250, with which to credit a payment charge value (e.g., when the script has an associated payment charge value).

Payment charge field 450 may include information to identify a payment charge value associated with a particular script. For example, provider server 250 may provide the particular script to script server 230 for delivery to user device 210 for a cost corresponding to the payment charge value. As an example, payment charge field 450 may store information to identify a payment charge value of $0.99 for the script ID of 5128, and a payment charge value of $0.49 for the script ID of 8456.

Authorized user device IDs field 460 may include information to identify particular user devices 210 that are authorized to receive a particular script. For example, an owner of the particular script (e.g., provider server 250, a particular user device 210, etc.) may provide information to identify user devices 210 that are authorized to receive the particular script. In some implementations, authorized user device IDs field 460 may store information to identify that any user device 210 may receive a particular script. For example, authorized user device IDs field 460 may store an indication, such as “public,” to identify that the particular script is authorized to be received by any user device 210.

While particular fields are shown in a particular format in data structure 400, in practice, data structure 400 may include additional fields, fewer fields, different fields, or differently arranged fields than are shown in FIG. 4. For example, data structure 400 may store information for individual scripts, such as user ratings, default scripts to provide to user device 210 when multiple scripts exist for a particular content file, and/or some other information associated with scripts.

FIG. 5 illustrates an example data structure 500 that may be stored by one or more devices in environment 200, such as script server 230. In one implementation, data structure 500 may be stored in a memory of script server 230. In another implementation, data structure 400 may be stored in a memory separate from, but accessible by, script server 230. In some implementations, data structure 400 may be stored by some other device in environment 200, such as discovery server 220, billing server 240, or provider server 250.

A particular instance of data structure 500 may contain different information and/or fields than another instance of data structure 500. In some implementations, data structure 500 may correspond to instructions associated with a particular script. Another instance of data structure 500 may correspond to instructions associated with another script.

As shown in FIG. 5, data structure 500 may include script ID field 510 and script instructions field 520.

Script ID field 510 may store information to identify a script stored by script server 230 and corresponding to a script ID stored by script ID field 430.

Script instructions field 520 may store instructions associated with the particular script of data structure 500. In some implementations, script instructions field 520 may store an instruction which user device 210 may execute. In some implementations, script instructions field 520 may store instructions which user device 210 may execute in a particular order. For example, script instructions field 520 may store an instruction, such as PLAY(300) to initiate playback of a corresponding content file for 300 seconds. Script instructions field 520 may store an instruction, such as PAUSE(10) to pause playback of the corresponding content file for 10 seconds after initiating playback for 300 seconds. Script instructions field 520 may store an instruction, such as SKIP(30) to fast forward playback of the corresponding content file for 30 seconds. Script instructions field 520 may store an instruction, such as PLAY(END) to initiate playback of the corresponding content file until the end of the content file. Additionally, or alternatively, script instructions field 520 may store an instruction to modify the playback of the corresponding content file in some other manner.

While particular fields are shown in a particular format in data structure 500, in practice, data structure 500 may include additional fields, fewer fields, different fields, or differently arranged fields than are shown in FIG. 5.

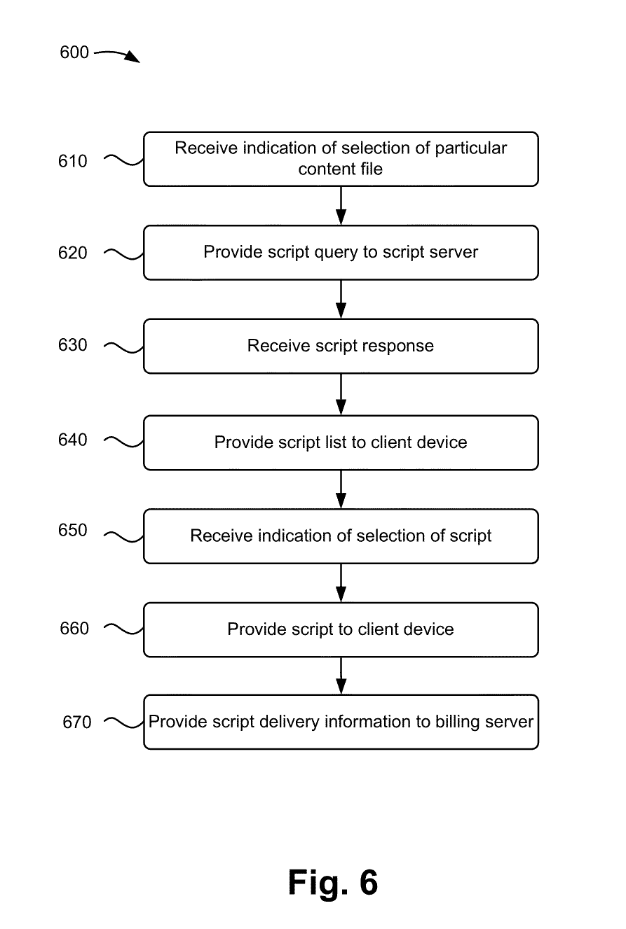

FIG. 6 illustrates a flowchart of an example process 600 for providing a script to user device 210. In one implementation, process 600 may be performed by one or more components of discovery server 220. In another implementation, some or all of blocks of process 600 may be performed by one or more components of another device in environment 200 (e.g., script server 230, billing server 240, or provider server 250), or a group of devices including or excluding discovery server 220.

As shown in FIG. 6, process 600 may include receiving an indication of selection of a particular content file (block 610). For example, discovery server 220 may receive an indication of selection of the particular content from user device 210 (e.g., when user device 210 requests to receive the particular content file from provider server 250). In some implementations, user device 210 may provide the selection of the particular content to discovery server 220 via a content platform of user device 210 or via a user interface of user device 210. Discovery server 220 may identify information regarding the particular content file, such as an identifier associated with the particular content file. Additionally, discovery server 220 may receive information regarding user device 210, such as an identifier associated with user device 210, when receiving the indication of the selection of the particular content file.

Process 600 may also include providing a script query to script server 230 (block 620). For example, discovery server 220 may provide the identifier associated with the particular content file and the identifier associated with the user device to script server 230 as part of a script query to script server 230. In some implementations, the script query may include a request for information to identify whether a script, associated with the particular content file, is being stored by script server 230. In some implementations, script server 230 may identify whether a script, associated with the particular content file, is being stored by performing a search for the identifier of the particular content file in data structure 400 (e.g., in file ID field 410). Additionally, script server 230 may determine whether user device 210 is authorized to receive an identified script file based on performing a search for the identifier of user device 210 in data structure 400 (e.g., in authorized user device IDs field 460).

Process 600 may further include receiving a script response (block 630). For example, discovery server 220 may receive the script response from script server 230 based on providing script server 230 with the script query and based on script server 230 identifying whether a script is being stored by script server 230, as described above. In some implementations, the script response may include a script list to identify one or more scripts associated with the particular content file, and may include information for each script, such as a script identifier, a script description, and/or a payment charge value. Alternatively, the script response may include an indication that script server 230 is not storing a script associated with the particular content file.

Process 600 may also include providing the script list to the user device (block 640). For example, discovery server 220 may provide the script list to user device 210 based on receiving the script list, as described above. In some implementations, user device 210 may present the script list on a content platform or a user interface of user device 210. For example, user device 210 may present the script list including a description of each script in the script list, an associated payment charge value of each script, and/or some other information regarding each script. In some implementations, the script list may list scripts in order of popularity (e.g., based on a number of requests for the scripts), ratings (e.g., based on user feedback ratings), payment charge values, or in some other order. In some implementations, the script may direct user device 210 to request, from a user of user device 210, information regarding a rating of the script (e.g., a “thumbs up” or “thumbs down” voting system, or some other type of rating system to rate the script).

Process 600 may further include receiving an indication of the selection of a script (block 650). For example, discovery server 220 may receive an indication of the selection of a script when a user, associated with user device 210, selects a particular script via the content platform or user interface of user device 210. In some implementations, discovery server 220 may receive an indication of a selection to omit providing user device 210 with a script (e.g., when a user, of user device 210, selects to not apply a script to the particular content file or selects to forgo an associated payment charge value of a script).

Process 600 may also include providing a script to the user device (block 660). For example, discovery server 220 may send an instruction to script server 230 to direct script server 230 to provide a script to user device 210. In some implementations, the script may correspond to the selected script, as described above with respect to block 650. Alternatively, the script may correspond to a default script. Alternatively, the script may correspond to a single script associated with the particular content file (e.g., when script server 230 stores a single script associated with the particular content file). As described above, user device 210 may apply the script to the particular content file by executing instructions associated with the script (e.g., instructions that direct user device to begin playback of the particular content file, to fast forward during a time period associated with a commercial time period of the particular content file, or modify playback of the particular content file in some other manner).

Process 600 may also include providing script delivery information to a billing server (block 670). For example, discovery server 220 may provide information to billing server 240 that a particular script having, an associated payment charge, has been delivered to user device 210. In some implementations, discovery server 220 may also provide information regarding user device 210 (e.g., an identifier of user device 210, an account number associated with a user of user device 210, etc.) and may provide a provider ID, associated with the script, to billing server 240. As described above, billing server 240 may perform a billing settlement function based on script delivery information received by discovery server 220.

While a particular series of blocks has been described above with regard to FIG. 6, the operations, data flows and/or the order of the blocks may be modified in other implementations. Further, non-dependent operations and/or data flows may be performed in parallel.

In some implementations, block 640-650 may be omitted when script server 230 stores a single script associated with the particular content and/or when a default script is associated with the particular content file. Further, blocks 660-670 may be omitted when discovery server 220 receives a selection, from user device 210, to not provide user device 210 with a script. Additionally, block 670 may be omitted when no payment charge value is associated with the script provided to user device 210.

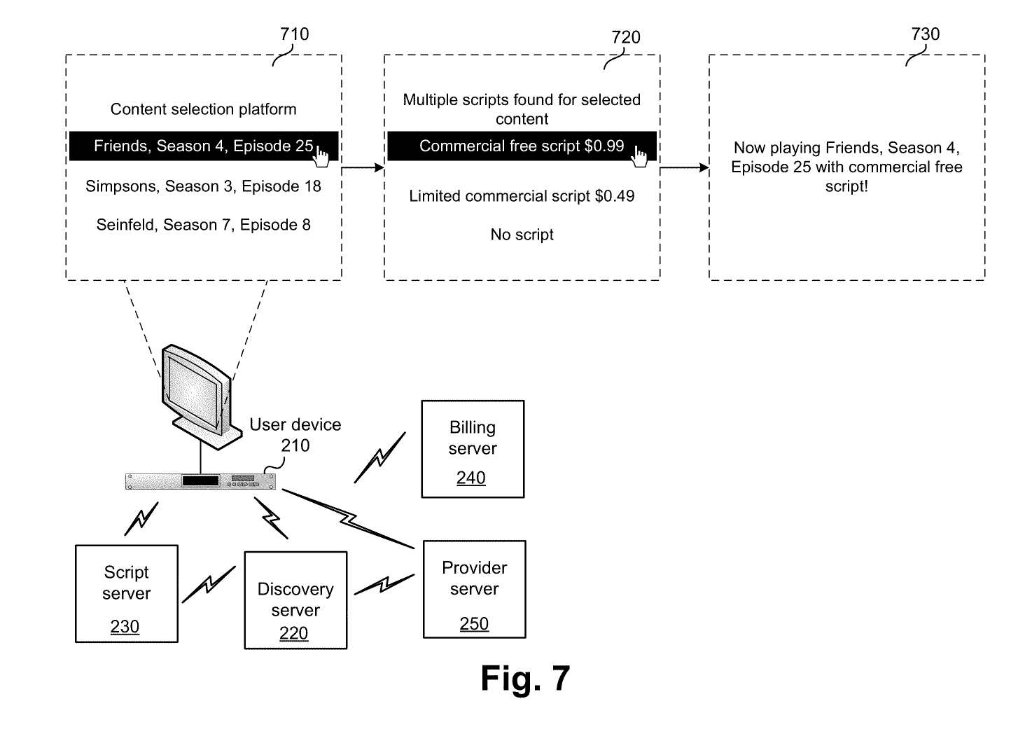

FIG. 7 illustrates an example use case as described herein. As shown in interface 710, a user, associated with user device 210, requests to receive, from provider server 250, a particular content file (e.g., via a content selection platform) associated with the description “Friends, season 4, episode 25.” As described above, discovery server 220 may receive an indication of selection of the particular content file, an identifier of the particular content file, an identifier of user device 210, and provide the identifier of the particular content file and the identifier of user device 210 to script server 230 as a script query. Script server 230 may perform a search to identify scripts associated with the particular content file (e.g., based on the identifier of the particular content file) and may perform a search for the identifier of user device 210 associated with identified scripts. Script server 230 may provide, to discovery server 220, a query response having a list of scripts associated with the particular content file.

In FIG. 7, assume that script server 230 identifies two scripts associated with the particular content file and that user device 210 is authorized to receive the scripts. Given this assumption, script server 230 may provide, to discovery server 220, a script list having information regarding the two scripts (e.g., descriptions associated with each script). As shown in interface 720, discovery server 220 may provide the script list to user device 210 such that user device 210 may present the script list on an associated display to permit a user of user device 210 to select a particular script. In FIG. 7, assume that the user of user device 210 selects the script having the description “Commercial free script.” Further assume that the script, selected by the user of user device 210, has an advertised payment charge value of $0.99. As shown in interface 730, user device 210 may receive the selected script from script server 230 and may execute the script to modify playback of the particular content. In the example shown in FIG. 7, the script may include an instruction to direct user device 210 to modify playback of the particular content file to fast forward or skip the commercials when playing Friends season 4, episode 25.

As further shown in FIG. 7, discovery server 220 may communicate with billing server 240 and provide billing server 240 with an indication that a particular script, associated with a particular provider server 250 and an associated payment charge, has been delivered to user device 210. In some implementations, billing server 240 may perform a billing settlement function to assess debits and credits to accounts of user device 210 and provider server 250. For example, billing server 240 may credit the account of provider server 250 by a value corresponding to the payment charge value of the particular script and may debit the account of user device 210 by a value corresponding to the payment charge value.

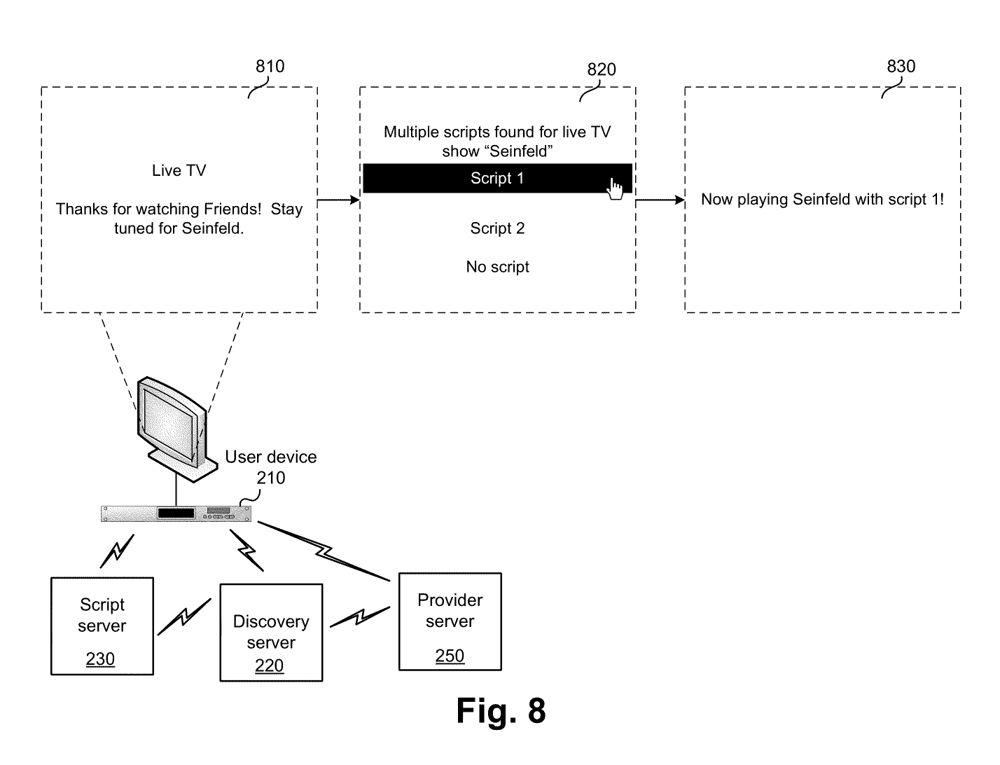

FIG. 8 illustrates an example use case as described herein. In FIG. 8, assume that user device 210 is currently accessing a first content file associated with a live television broadcast. Further, assume that playback for the first content file ends (e.g., as a result of a scheduled broadcast of the first content file ending, and as shown in interface 810). Further, assume that that user device 210 accesses a second content file at a scheduled broadcast time subsequent to the end of the broadcast of the first content file. Given these assumptions, discovery server 220 may identify that user device 210 selects the second content by accessing the second content file via a live broadcast when the second content file is scheduled to be broadcasted. As described above, discovery server 220 may identify a script, associated with the second content file, and may provide the script to user device 210 in accordance with the description above (e.g., as shown in interfaces 820 and 830).

As described above, different content files may include respective scripts with instructions to direct user device 210 to start playback, pause playback, rewind playback, fast forward playback, or modify playback of a particular content file in some other manner. In some implementations, a particular script may be associated with a payment charge value, such as a payment charge value. Thus, a user, associated with the user device, may agree to incur a charge in exchange for being able to use the script. Further, each content file may be associated with a script that directs the user device to skip a portion of the content file having an advertisement, or directs the user device to modify playback of the content file in some other manner.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method comprising:
receiving, by a first server and from a user device, an indication of a selection of a particular content file,
the user device selecting the particular content file to request the particular content file;
providing, by the first server, a first query to request a script list having a list of one or more scripts, associated with the particular content file,
each one of the one or more scripts including an instruction to direct the user device to modify playback of the particular content file;
receiving, by the first server, a response to the first query including the script list; and
providing, by the first server, one of the one or more scripts to the user device,
the user device being capable of executing the instruction of the one of the one or more scripts to modify playback of the particular content file when the user device plays the particular content file.

2. The method of claim 1, where the script list identifies a plurality of scripts associated with the particular content file, the method further comprising:
providing the script list to the user device; and
receiving an indication of selection of one of the plurality of scripts from the user device;
where providing the one of the one or more scripts to the user device includes providing the one of the plurality of scripts.

3. The method of claim 2, further comprising:
sorting the script list, based on rating information, a payment charge value, or popularity information associated with the plurality of scripts, to form a sorted script list,
where providing the script list to the user device includes providing the sorted script list.

4. The method of claim 1, where the one of the one or more scripts is associated with a payment charge value, the method further comprising:
providing an indication to a billing server that the one of the one or more scripts has been provided to the user device,
the billing server performing a billing settlement function to assess a debit or credit to an account associated with the user device or to an account associated with a server that provides the particular content file to the user device.

5. The method of claim 1, where the instruction to modify the playback of the particular content file includes an instruction to begin playback and fast forward playback of the particular content file at a particular time index, or an instruction to begin playback and pause playback of the particular content file at a particular time index.

6. The method of claim 1, where the instruction to modify the playback of the particular content file includes an instruction to pause, rewind, or fast forward playback of the particular content file at a particular time index of the particular content file.

7. The method of claim 1, where the script list identifies a default script,
where the one of the one or more scripts provided to the user device corresponds to the default script.

8. A system comprising:
one or more servers to:
receive, from a user device, an indication of a selection of a particular content file,
the user device selecting the particular content file to request the particular content file;
determine a script list having a list of one or more scripts, associated with the particular content file,
each of the one or more scripts including an instruction to direct the user device to modify playback of the particular content file; and
provide one of the one or more scripts to the user device,
the user device being capable of executing the instruction of the one of the one or more scripts to modify playback of the particular content file when the user device plays the particular content file.

9. The system of claim 8, where the script list identifies a plurality of scripts associated with the particular content file, and the one or more servers are further to:
provide the script list to the user device; and
receive an indication of selection of one of the plurality of scripts from the user device;
where when providing the one of the one or more scripts to the user device, the one or more servers are further to provide the one of the plurality of scripts.

10. The system of claim 9, where the one or more servers are further to:
sort the script list, based on rating information, a payment charge value, or popularity information associated with the plurality of scripts, to form a sorted script list,
where when providing the script list to the user device, the one or more servers are further to provide the sorted script list.

11. The system of claim 8, where the one of the one or more scripts is associated with a payment charge value, and the one or more servers are further to:
provide an indication to a billing server that the one of the one or more scripts has been provided to the user device,
the billing server performing a billing settlement function to assess a debit or credit to an account associated with the user device or to an account associated with a server that provides the particular content file to the user device.

12. The system of claim 8, where the instruction to modify the playback of the particular content file includes an instruction to begin playback and fast forward playback of the particular content file at a particular time index, or an instruction to begin playback and pause playback of the particular content file at a particular time index.

13. The system of claim 8, where the instruction to modify the playback of the particular content file includes an instruction to pause, rewind, or fast forward playback of the particular content file at a particular time index of the particular content file.

14. The system of claim 8, where the script list identifies a default script,
where the one of the one or more scripts provided to the user device corresponds to the default script.

15. A computer-readable medium for storing instructions, the instructions comprising:
a plurality of instructions which, when executed by one or more processors associated with a first server, cause the one or more processors to:
receive, from a user device, an indication of a selection of a particular content file,
the user device selecting the particular content file to request the particular content file;
provide a first query to request a script list having a list of one or more scripts associated with the particular content file,
each one of the one or more scripts including an instruction to direct the user device to modify playback of the particular content file,
the instruction to direct the user device to modify playback of the particular content file including an instruction to pause, rewind, or fast forward playback of the particular content file at a particular time index of the particular content file;
receive a response to the first query including the script list; and
provide one of the one or more scripts to the user device,
the user device being capable of executing the instruction of the one of the one or more scripts to modify playback of the particular content file when the user device plays the particular content file from the second server.

16. The computer-readable medium of claim 15, where the script list identifies a plurality of scripts associated with the particular content file, and the plurality of instructions further cause the one or more processors to:
provide the script list to the user device; and
receive an indication of selection of one of the plurality of scripts from the user device;
where one or more instructions, of the plurality of instructions, to provide the one of the one or more scripts to the user device, further cause the one or more processors to provide the one of the plurality of scripts.

17. The computer-readable medium of claim 15, where the plurality of instructions further cause the one or more processors to:
sort the script list, based on rating information, a payment charge value, or popularity information associated with the plurality of scripts, to form a sorted script list,
where one or more instructions, of the plurality of instructions to provide the script list to the user device, further cause the one or more processors to provide the sorted script list.

18. The computer-readable medium of claim 15, where the one of the one or more scripts is associated with a payment charge value, and the plurality of instructions further cause the one or more processors to:
provide an indication to a billing server that the one of the one or more scripts has been provided to the user device,
the billing server performing a billing settlement function to assess a debit or credit to an account associated with the user device or to an account associated with a server that provides the particular content file to the user device.

19. The computer-readable medium of claim 15, where the instruction to modify the playback of the particular content file includes an instruction to begin playback and fast forward or rewind playback of the particular content file at a particular time index, or an instruction to begin playback and pause playback of the particular content file at a particular time index.

20. The computer-readable medium of claim 15, where the script list identifies a default script,
where the one of the one or more scripts provided to the user device corresponds to the default script.
